(19) United States
(12) Patent Application Publication
(10) Pub. No.: US 2009/0065546 A1
(43) Pub. Date: Mar. 12, 2009

(54) Accessory facilitating manual dispensing of toilet paper

(76) Inventor: John D. Bilotti, Kenosha, WI (US)

Correspondence Address: JANSSON SHUPE & MUNGER LTD., 245 MAIN STREET, RACINE, WI, 53403, US

(21) Appl. No.: 11/878,968

(22) Filed: Jul. 30, 2007

(51) Int. Cl. A47K 10/32; B26F 3/02

(52) U.S. Cl. 225/88

(57) ABSTRACT

The invention is an accessory facilitating manual, sanitary dispensing of toilet paper from a dispenser rotatably holding a toilet paper roll, the accessory including front and back guide-members defining a paper-movement channel therebetween and having access openings allowing manual engagement of paper in the channel, a paper-detaching edge at the lower end of the guide members, and a dispenser-attaching device at the upper end of the guide-members. In another form, the invention is a complete dispenser incorporating similar apparatus.

### FIELD OF THE INVENTION

The present invention is related generally to toilet paper dispensing and, more specifically, to apparatus for dispensing of toilet paper from a roll, as in public restroom facilities.

### BACKGROUND OF THE INVENTION

Many public restrooms provide toilet paper in large rolls for which special paper-dispensers have been designed. There is a wide variety of different designs and types of such dispensers with a common principle of operation which is based on having the large roll of paper fully concealed inside the dispenser and an end of the paper hanging from an opening in a bottom of the dispenser below the paper roll. The user grabs and pulls the end of the paper to rotate the roll and obtain a desired length of the paper, which the user then tears off at the bottom of the dispenser.

Toilet paper in most rolls also has perforations dividing a very long continuous length of the paper into sheets of a certain size, a group of which can be easily separated at a perforation line by a sharp pull. Very often, because of such perforations or just because of the thinness and nature of the toilet paper, a simple pull can inadvertently tear the paper at a position inside the dispenser such that the new end of the paper is out of reach of the user, perhaps apart from some extreme hand-maneuver into the bottom of the dispenser. In some other cases, even if the paper is torn at the bottom of the dispenser, the released roll bounces with a backward rotation and pulls the end of the paper inside the dispenser, with the same resulting problem.

In the situations like the ones just described, the user is forced to attempt to find the paper end by reaching inside of the dispenser or trying to manipulate the roll by touching it through the opening in the bottom of the dispenser and rotating it in one or the other direction until the paper end is finally in position to be grasped for further dispensing. Such actions are highly unsanitary because repeated touching of the dispenser and portions of the paper roll by multiple users at least some of which have contaminated fingers can readily expose users to contamination and infection—not to mention concern about contamination and the frustration that accompanies difficulty of use.

In addition, reaching inside the dispenser while not adequately seeing the details of its structure (including any paper-breakage edge, which may be serrated or sharp in some manner) may even result in scratching or puncturing the user's skin, thus further exposing the user to the spread of infection. This becomes an even larger issue if the user is a disabled person with limited movement ability which makes reaching the paper end inside the dispenser a particularly difficult task.

There is a need for an improvement in toilet paper dispensing to allow easy access to the toilet paper.

### OBJECTS OF THE INVENTION

It is an object of the invention to provide improved, simpler dispensing of toilet paper overcoming some of the problems and shortcomings of the prior art, including those referred to above.

Another object of the invention is to provide improved dispensing of toilet paper which allows for easy access to the end of the paper and easy unrolling of the paper.

Another object of the invention is to provide improved dispensing of toilet paper from a large roll such that the end of the paper remains outside of the dispenser in which the roll is mounted after tearing away of a length of paper.

Still another object of the invention is to provide improved dispensing of toilet paper (from a fairly inaccessible roll) which minimizes contamination of the dispenser and the paper roll.

Yet another object of the invention is to provide improved dispensing of toilet paper with increased sanitation and minimized risk of injury to a user's hand.

Another object of this invention is to provide a mechanism to be added to paper-dispensing apparatus to facilitate overcoming the problems referred to above.

Still another object of the present invention is to provide an improved, simpler large-roll toilet paper dispenser for use in public facilities and otherwise.

How these and other objects are accomplished will become apparent from the following descriptions and the drawings.

### SUMMARY OF THE INVENTION

The present invention is an accessory facilitating manual dispensing of toilet paper from a dispenser rotatably holding a toilet paper roll which has an axis. The inventive accessory includes: front and back guide-members defining a paper-movement channel therebetween, at least the front guide-member having at least one access opening allowing manual engagement of paper in the channel; a paper-detaching edge at the lower end of the guide members; and a dispenser-attaching device at the upper end of the guide-members.

It is preferred that the front and back guide-members be substantially vertical in their position of use, and preferably substantially planar. The planar guide members are preferably closely adjacent to each other with only a thin space between them, sufficient to allow easy movement of a length of toilet paper therebetween while keeping such length of toilet paper in a determined position allowing easy grasping thereof at an access opening. It is highly preferred that the guide-members extend along planes which are substantially parallel to the axis of the toilet paper roll.

In highly preferred embodiments of the present invention, the front guide-member has two opposed lateral access openings. Such access openings are preferably substantial notches in vertical sides of the front guide-member. In such highly preferred embodiments, it is further preferred that the back guide-member have opposed lateral access openings which at least partially overlap (and preferably fully overlap) the access openings of the front guide-member, thereby allowing manual pinching/pulling of paper in the channel to facilitate dispensing. The access openings of the back guide-member are also preferably notches in vertical sides of the back guide-member.

In certain preferred embodiments of the accessory, at least the front guide-member preferably has a bottom access opening allowing manual engagement of paper in the channel near the paper-detaching edge. In preferred versions of such embodiments, the back guide-member also has a bottom access opening at least partially overlapping (and preferably fully overlapping) the bottom access opening of the front guide-member, thereby allowing manual pinching/pulling of paper in the channel near the paper-detaching edge to facilitate dispensing.

In most highly preferred embodiments, the dispenser-attaching device is pivotably securable to the dispenser. The dispenser-attaching device is preferably configured and arranged for suspending the accessory in a position below the paper dispenser. The dispensing accessory of the present invention may be adapted for attachment to a variety of currently existing toilet paper dispensers used in public restrooms.

It is highly preferred that the front and back guide-members be flexible. The term “flexible” as used herein means non-rigid, able to flex slightly from planar to somewhat off-planar orientations.

The present invention also includes a toilet paper dispensing device which incorporates the principal structures of the accessory into the dispenser itself. In such cases the vertical dimensions of the apparatus may be somewhat less then the overall vertical dimensions of a dispenser with the accessory.

Principal uses of the invention are expected to be with the types of dispensers used in public facilities—i.e., dispensers designed to accommodate very large rolls of toilet paper. The large roll in a typical dispenser of this type is mounted therein with its axis perpendicular to the restroom wall on which the dispenser is mounted. It should be noted, however, that the current invention can be adapted for use with different types of dispensers for different sizes of paper rolls. Thus, the present disclosure is in no way limiting to any particular dispenser design or paper roll size.

The toilet paper-dispensing device of this invention includes: a dispenser body holding the toilet paper roll; front and back guide-members defining a paper-movement channel therebetween and secured with respect to the dispenser body, at least the front guide-member having opposed lateral access openings allowing manual engagement of paper in the channel; and a paper-detaching edge is at the lower end of the guide members.

In highly preferred versions of such inventive dispensers, the front and back guide-members have upper ends pivotably secured with respect to the dispenser body. The guide-members are preferably suspended below the dispenser body.

### BRIEF DESCRIPTION OF THE DRAWINGS

FIG. 1 is a perspective view of a toilet paper dispenser having an accessory in accordance with this invention.

FIG. 2 is an enlarged fragmentary front elevation, showing the accessory of FIG. 1.

FIG. 3 is a side sectional view taken along section 3-3 as indicated in FIG. 2.

FIG. 4 is an enlarged fragmentary view of FIG. 3, showing detail of the accessory.

FIG. 5 is an enlarged fragmentary view similar to FIG. 4, but showing the flexibility of the accessory.

FIG. 6 is a perspective view of a toilet paper dispensing device in accordance with the present invention.

### DETAILED DESCRIPTION OF PREFERRED EMBODIMENTS

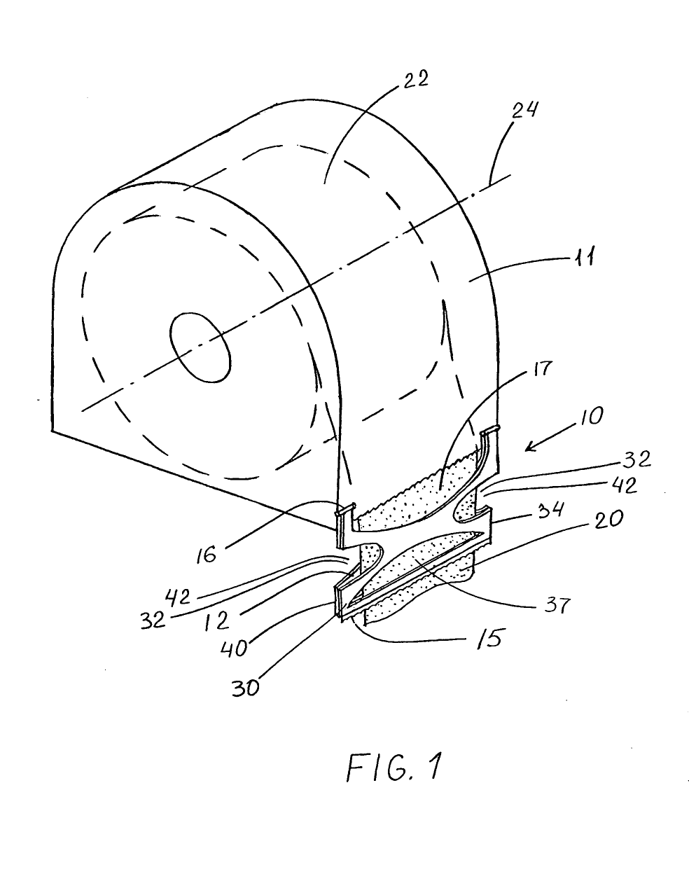

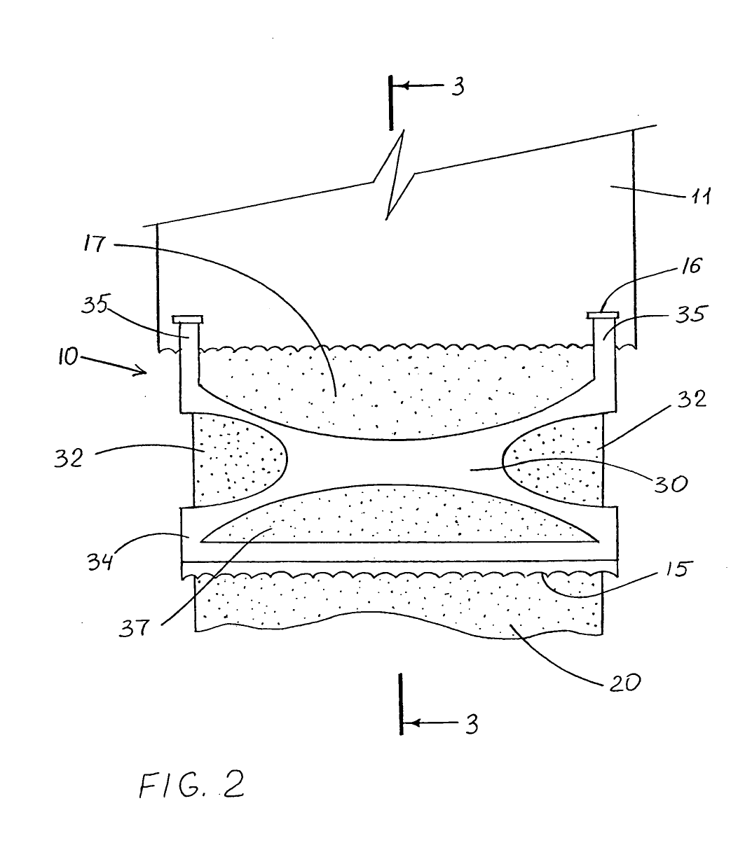

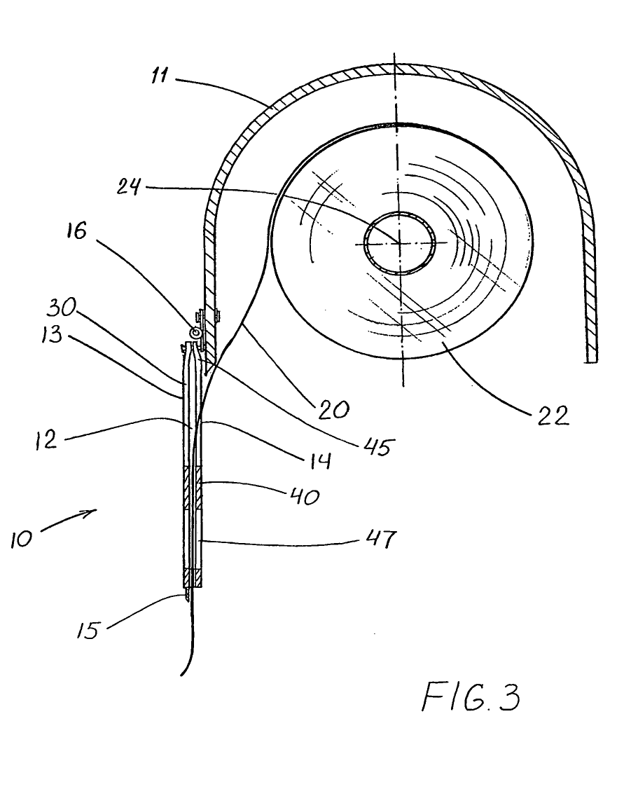

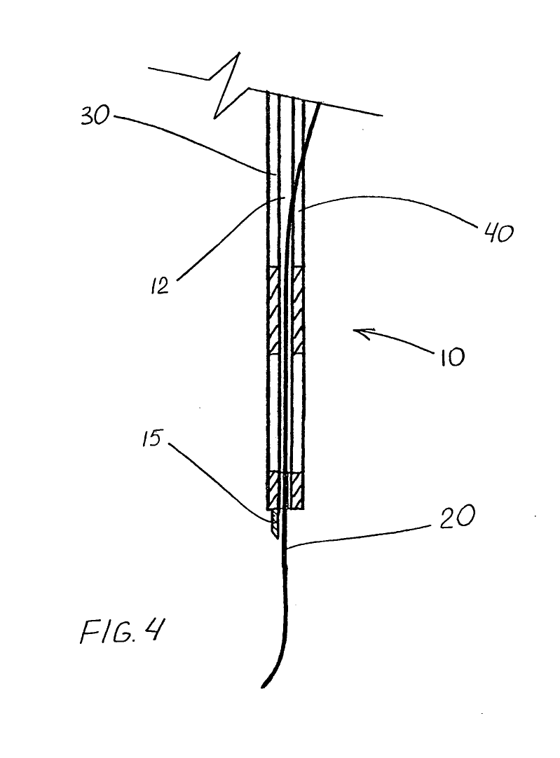

FIGS. 1-4 show an inventive accessory 10 facilitating manual dispensing of toilet paper 20 from a dispenser 11 which rotatably holds a toilet paper roll 22 which has an axis 24. The accessory includes front guide-member 30 and back guide-member 40 defining a paper-movement channel 12 therebetween. As best seen in FIG. 3, guide-members 30 and 40 extend along planes 13 and 14, respectively, which are substantially parallel to axis 24 of toilet paper roll 22. Front guide-member 30 has a pair of lateral access openings 32 and a bottom access opening 37. Likewise, back guide-member 40 has a pair of lateral access openings 42 and a bottom access opening 47 in alignment with lateral access openings 32 and bottom access opening 37, respectively. These access openings allow manual engagement of paper 20 in channel 12 to facilitate withdrawal from dispenser 11.

A paper-detaching edge 15 is at the lower end 34 of front guide member 30. Dispenser-attaching devices 16 are at upper ends 35 and 45 of guide-members 30 and 40, and serve to attach accessory 10 to dispenser 11. Attaching devices 16 are hinges such that accessory 12 is pivotably secured to dispenser 11. Dispensing accessory 10 may be easily adapted for attachment to a variety of currently existing toilet paper dispensers used in public restrooms.

FIGS. 3-5 best show that guide members 30 and 40 are closely adjacent to each other, while still allowing unimpeded paper movement through channel 12 therebetween. As can be seen in the FIGS. 1, 2 and 6, accessory 10 also includes an upper access opening 17 which can be used to facilitate insertion of the end of the toilet paper roll from dispenser 11 into channel 12.

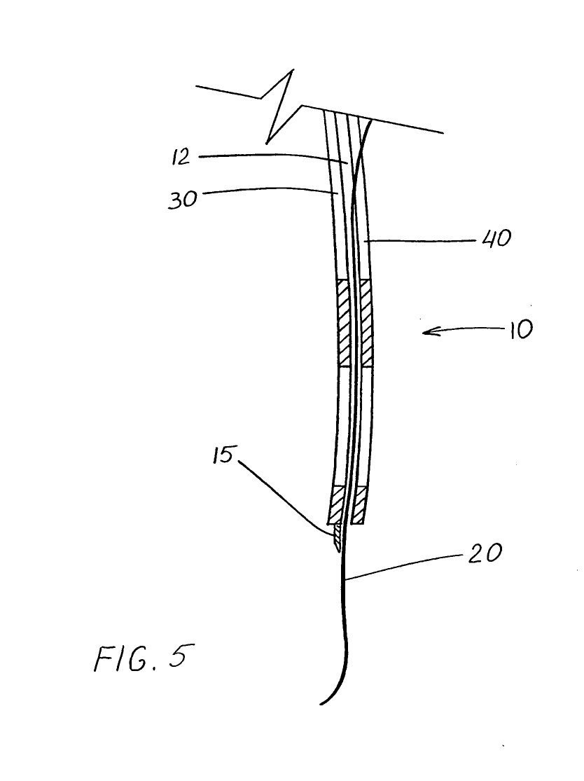

FIG. 5 shows that substantially planar front and back guide-members 30 and 40 are flexible, and may be made of any of a wide variety of materials such as flexible plastics which are well-known to those skilled in the art.

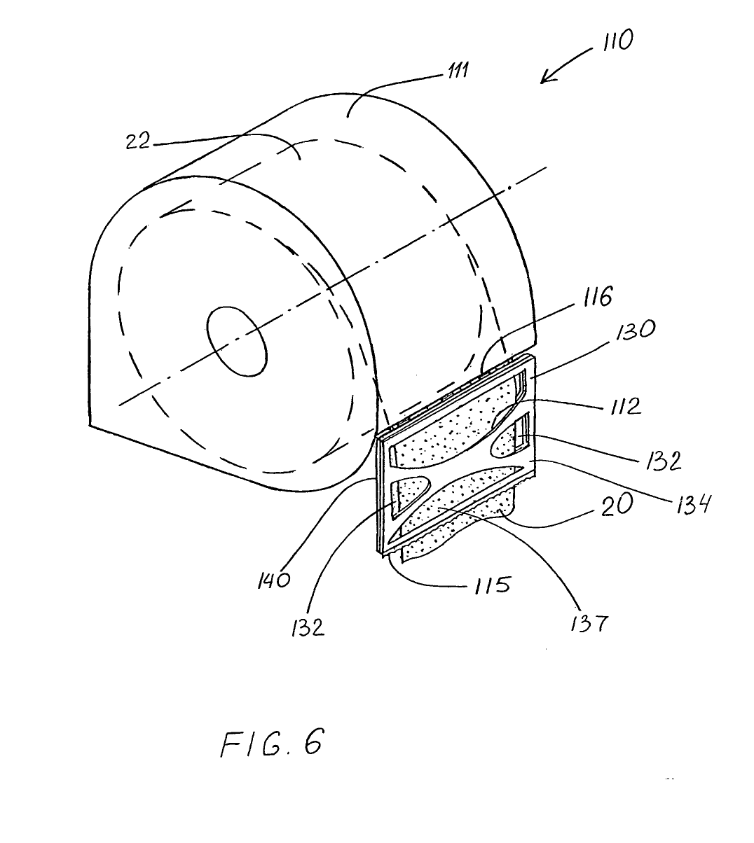

FIG. 6 illustrates a toilet paper dispenser 110 having the characteristics and features of the invention incorporated therein. Dispensing device 110 includes a dispenser body 111 holding toilet paper roll 22. Front and back guide-members 130 and 140 defining a paper-movement channel 112 therebetween and are secured with respect to body 111 by a more substantial hinge 116. Front guide-member 130 has lateral access openings 132 and a lower access opening 137. A paper-detaching edge 115 is at lower end 134 of front guide-member 130.

While the principles of the invention have been shown and described in connection with specific embodiments, it is to be understood that such embodiments are by way of example and are not limiting.

1. An accessory facilitating manual dispensing of toilet paper from a dispenser rotatably holding a toilet paper roll having an axis, the accessory comprising:
front and back guide-members defining a paper-movement channel therebetween, at least the front guide-member having at least one access opening allowing manual engagement of paper in the channel;
a dispenser-attaching device at the upper end of the guide-members; and
a paper-detaching edge at the lower end of the guide members.

2. The accessory of claim 1 wherein the front and back guide-members are substantially vertical.

3. The accessory of claim 1 wherein the front and back guide-members are substantially planar.

4. The accessory of claim 3 wherein the front and back guide-members are substantially vertical.

5. The accessory of claim 1 wherein the front guide-member having two opposed lateral access openings.

6. The accessory of claim 5 wherein the access openings are notches in vertical sides of the front guide-member.

7. The accessory of claim 5 wherein the back guide-member has opposed lateral access openings at least partially overlapping the assess openings of the front guide-member, thereby allowing manual pinching of paper in the channel to facilitate dispensing.

8. The accessory of claim 7 wherein the access openings are notches in vertical sides of the guide-members.

9. The accessory of claim 1 wherein at least the front guide-member has a bottom access opening allowing manual engagement of paper in the channel near the paper-detaching edge.

10. The accessory of claim 9 wherein the back guide-member has a bottom access opening at least partially overlapping the bottom access opening of the front guide-member, thereby allowing manual pinching of paper in the channel near the paper-detaching edge to facilitate dispensing.

11. The accessory of claim 1 wherein the guide-members extend along planes which are substantially parallel to the axis.

12. The accessory of claim 1 wherein the dispenser-attaching device is pivotably securable to the dispenser.

13. The accessory of claim 12 wherein the dispenser-attaching device is configured and arranged for suspending the accessory in a position below the paper dispenser.

14. The accessory of claim 1 wherein the front and back guide-members are flexible.

15. A device for manual dispensing of toilet paper from a roll having an axis, comprising:
a dispenser body holding the toilet paper roll;
front and back guide-members defining a paper-movement channel therebetween and secured with respect to the dispenser body, at least the front guide-member having opposed lateral access openings allowing manual engagement of paper in the channel; and
a paper-detaching edge at the lower end of the guide members.

16. The toilet paper-dispensing device of claim 15 wherein the front and back guide-members are substantially vertical.

17. The toilet paper-dispensing device of claim 15 wherein the front and back guide-members are substantially planar.

18. The toilet paper-dispensing device of claim 17 wherein the front and back guide-members are substantially vertical.

19. The toilet paper-dispensing device of claim 15 wherein the access openings are notches in vertical sides of the front guide-member.

20. The toilet paper-dispensing device of claim 15 wherein the back guide-member has opposed lateral access openings at least partially overlapping the assess openings of the front guide-member, thereby allowing manual pinching of paper in the channel to facilitate dispensing.

21. The toilet paper-dispensing device of claim 20 wherein the access openings are notches in vertical sides of the guide-members.

22. The toilet paper-dispensing device of claim 15 wherein at least the front guide-member has a bottom access opening allowing manual engagement of paper in the channel near the paper-detaching edge.

23. The toilet paper-dispensing device of claim 22 wherein the back guide-member has a bottom access opening at least partially overlapping the bottom assess opening of the front guide-member, thereby allowing manual pinching of paper in the channel near the paper-detaching edge to facilitate dispensing.

24. The toilet paper-dispensing device of claim 15 wherein the guide-members extend along planes which are substantially parallel to the axis.

25. The toilet paper-dispensing device of claim 15 wherein the front and back guide-members have upper ends pivotably secured with respect to the dispenser body.

26. The toilet paper-dispensing device of claim 25 wherein the guide-members are suspended below the dispenser body.

27. The toilet paper-dispensing device of claim 15 wherein the front and back guide-members are flexible.
